(19) United States
(12) Patent Application Publication
(10) Pub. No.: US 2024/0396827 A1
(43) Pub. Date: Nov. 28, 2024

(54) Dampening Next Hop Updates in a Network Device

(71) Applicant: Arista Networks, Inc., Santa Clara, CA (US)

(72) Inventors: Sujit Kumar Sah, Bengaluru (IN); Trevor Siemens, Coquitlam (CA); Mayukh Saubhasik, Richmond (CA); Jesper Skriver, Latsia (CY)

(21) Appl. No.: 18/324,886

(22) Filed: May 26, 2023

(51) Int. Cl. H04L 45/00; H04L 45/58

(52) U.S. Cl. CPC H04L 45/20; H04L 45/58

(57) ABSTRACT

Requests to create entries in a hardware nexthop table can be delayed so that table entry creation rate can be dampened to reduce the occurrence of table overflow under certain transient conditions. When table utilization exceeds a threshold, received creation requests can be buffered instead of being processed right away. When table utilization falls below the threshold, received creation requests can be processed immediately without being buffered. Buffered creation requests can be periodically drained.

### BACKGROUND

Network devices (e.g., routers, multilayer switches, and the like) include functionality to route and/or forward network traffic. Forwarding tables are used to determine the next hop to which a data packet is forwarded. A next hop refers to the next closest (directly connected) network device a data packet can go through toward its destination.

Network devices take steps to update the information they use to route and/or forward traffic. When a new route is learned, for example, the next hop information in the forwarding tables can be updated to properly forward data packets. Updates can include creating (programming) new entries in the forwarding tables, updating existing entries, and deleting existing entries.

### BRIEF DESCRIPTION OF THE DRAWINGS

The present disclosure is directed to making updates to a hardware (HW) nexthop table, sometimes referred to as a hardware forwarding equivalence class table, that stores next hops, and in some embodiments stores next hop groups (NHGs). In accordance with some embodiments, adding new entries to the HW nexthop table can be delayed based on the level of utilization of the HW nexthop table (e.g., based on the percentage of used entries in the table) in order to avoid transient overflow of the table which can adversely affect traffic flow. Updates to existing entries and deletion of entries are not delayed.

In accordance with some embodiments, the rate of creating entries in the HW nexthop table can be slowed down when table utilization reaches a threshold level; e.g., when the HW nexthop table is 90% full. For example, when utilization is below the threshold, new entries can be immediately added to the HW nexthop table; e.g., without delay or buffering. When utilization reaches or exceeds the threshold, new entries can be backlogged (e.g., buffered in a table separate from the HW nexthop table) instead of being added to the HW nexthop table. A drainer task running in the background can periodically wake up and drain (write) one or more of the backlogged creation requests into the HW nexthop table.

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 represents a network system in accordance with some embodiments.

FIG. 2A represents a forwarding information base in accordance with some embodiments.

FIG. 2B represents a forwarding information base in accordance with some embodiments.

FIG. 3 represents a HW nexthop table update manager in accordance with some embodiments.

FIGS. 4 and 5 illustrate update operations in accordance with some embodiments,

FIG. 6 represents a network device that can be adapted in accordance with some embodiments.

### DETAILED DESCRIPTION

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

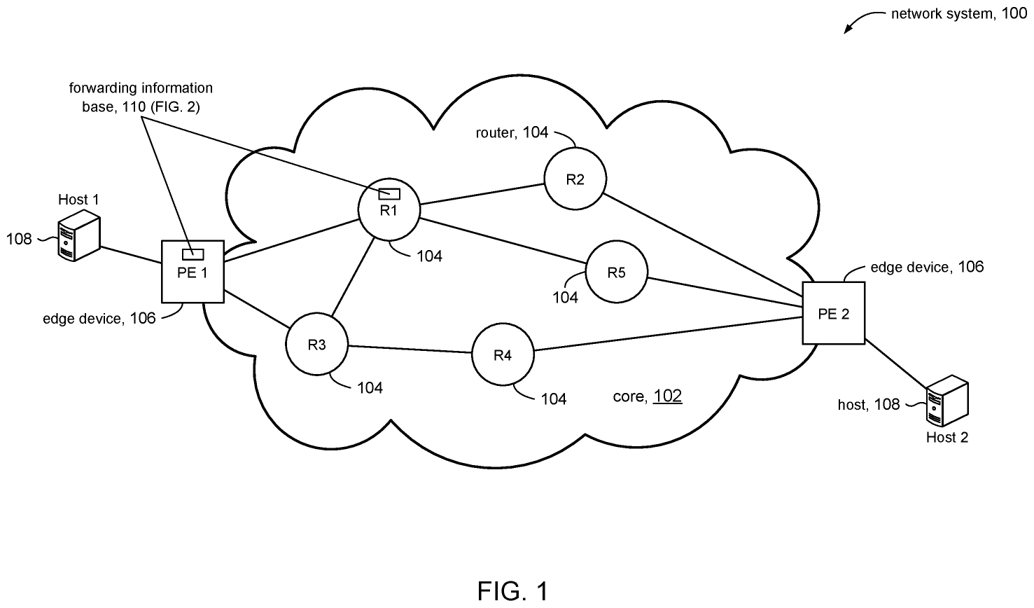

FIG. 1 shows a network system comprising network devices in accordance with the present disclosure. In some embodiments, network 100 can comprise a core network 102 comprising a deployment of interconnected core devices (e.g., routers, switches) 104. Network devices referred to as edge devices or provider edge (PE) devices 106 allow hosts machines (108) to communicate with each other across the core. Host machines 108 can communicate with each by exchanging data packets via edge devices 106 along various routes in core 102 defined by core devices 104.

Each network device 104, 106 includes packet processing and forwarding hardware (e.g., switch chips) to receive, process, and forward packets, and physical ports to connect to other devices to receive and transmit packets. Each port on a network device can be connected to another device. For example, the configuration in FIG. 1 shows that Host 1 is connected to a port on PE 1, router R1 is connected to another port on PE 1, and router R3 is connected to yet another port on PE 1. Likewise, FIG. 1 indicates that a port on R2 is connected to PE 2 and another port on R2 is connected to R1, and so on with the other network devices.

A next hop refers to the next closest (directly connected) network device a packet can go through. The next hop is a network device among a series of network devices that are connected together in a network, and is the next destination (sometimes selected from several candidate next hops) for a data packet from a given network device. FIG. 1, for instance, shows that for a packet to be transmitted from PE 1 to PE 2, there are two next hop candidates, R1 and R3. Likewise, for a packet to be transmitted from PE 2 to PE 1, there are three next hop candidates, R2, R4, and R5. Routers 104 in the core 102, likewise, have next hops. Consider for example, router R3. The next hops to forward a packet received from PE 1 include R1 and R4. The information used by the edge devices 106 and the core devices 104 to determine next hop can be stored in a forwarding information base 110.

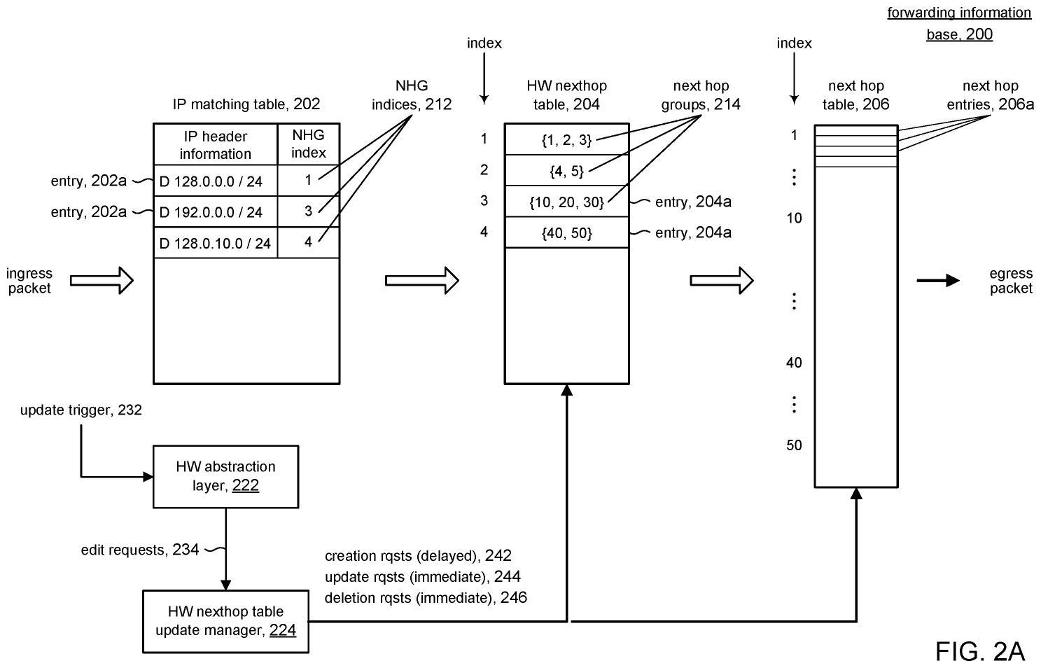

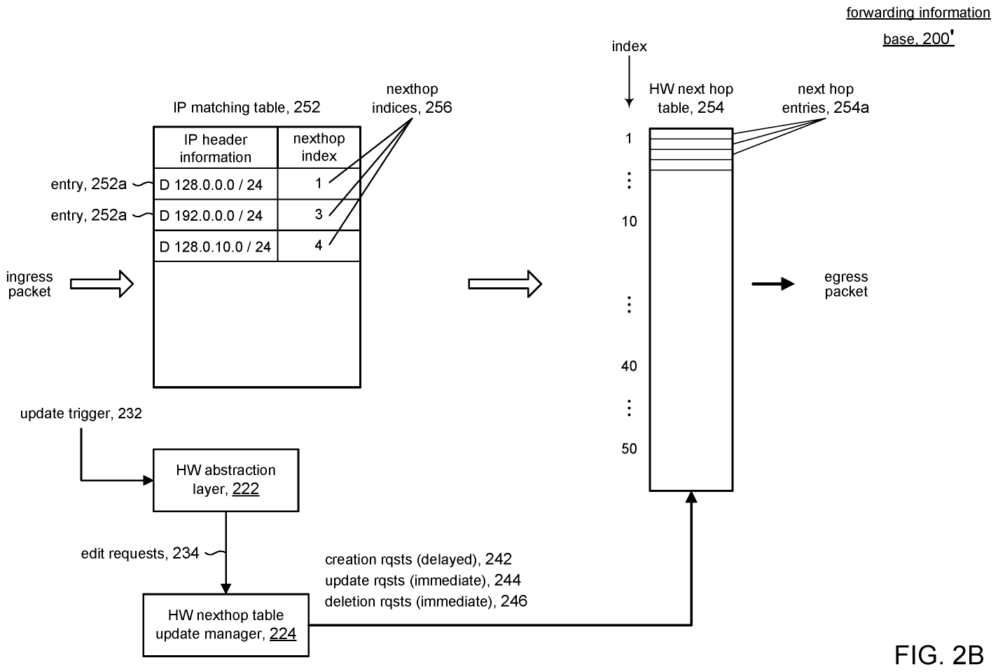

FIG. 2A shows a forwarding information base 200 in accordance with some embodiments of the present disclosure. Forwarding information base 200 can be a hardware-implemented database used by a network device for forwarding received traffic. In some embodiments, the forwarding information base 200 can comprise hardware tables including an internet protocol (IP) matching table 202, a hardware (HW) next hop table 204 of next hop groups (sometimes referred to as a hardware forwarding equivalence class table), and a next hop table 206. The hardware tables can include static random access memories (SRAMs), content-addressable memory (CAM), and the like.

The forwarding information base 200 is part of the egress pipeline (not shown) of the network device that receives ingress packets to be processed and forwarded as egress packets. With respect to the forwarding information base 200 shown in FIG. 2A, processing an ingress can include identifying an entry 202a in the IP matching table 202. Each entry 202a can include an “IP header information” data field and an “NHG index” data field. The IP header information data field can include information to match on portions of the IP header in the ingress packet. For instance, in the IP matching table example shown in FIG. 2A, the entries contain network prefixes, where each network prefix pertains to a destination in the network. It will be appreciated that in general the IP header information data field can comprise other portions of the IP header (destination port, protocol, source IP address, etc.) in addition to or instead of a network prefix. The NHG index data field contains an NHG index 212 that points to or otherwise references an entry in the HW nexthop table 204.

The HW nexthop table 204 comprises NHG entries 204a that include information used by the network device to forward an ingress packet toward the packet's destination. Each entry 204a comprises a group of next hops referred to herein as next hop group 214. Each next hop group 214 can include forwarding information pertaining to one or more next hops on one or more corresponding routes to a destination. Each member in a next hop group can be an index that points to or otherwise references an entry in the next hop table 206.

The next hop table 206 comprises next hop entries 206a. Each entry represents a next hop, and can include information that identifies a physical port on the network device that is connected to the next hop device on which an egress packet can be transmitted.

Briefly in operation, when an ingress packet is received, the network device can do a lookup in the IP matching table 202 to identify an entry 202a that matches some content in the IP header of the ingress packet. The matching entry will provide an index into the HW nexthop table. Using the example in FIG. 2, if the destination IP address contained in the IP header of the ingress packet is 192.0.0.128, then the matching entry in table 202 will give us an NHG index of ‘3’. The NHG index identifies an entry in the HW nexthop table 204, which in turn will determine a next hop group. In our example, an NHG index of ‘3’ will obtain the next hop group comprising the next hop entries 10, 20, and 30. One of the next hop entries in the obtained next hop group can be selected using a suitable algorithm; e.g., performing a modulo 3 operation on a hash value computed on a portion of the IP header of the ingress packet. The selected next hop entry can be used to identify an entry in the next hop table 206, which determines a port on the network device on which to transmit an egress packet generated from the ingress packet. It will be appreciated that the ingress packet may be processed to produce the egress packet.

FIG. 2A shows that the network device can include a HW abstraction layer 222 and an HW nexthop table update manager 224 to manage updates to the forwarding information base 200. In some embodiments, for example, the HW nexthop table 204 can be programmed by the HW abstraction layer 222 and the HW nexthop table update manager 224 based on route entries stored in a routing information base (not shown). In some embodiments, the HW nexthop table 204 can be written (programmed) during initialization of the network device; e.g., after powering on the device or after a reboot. Additionally, the HW abstraction layer 222 and HW nexthop table update manager 224 can update the HW nexthop table 204 while the network device is operating; for example, in response to update triggers 232 such as learning new routes, expiration of existing routes, route configuration by a user (e.g., network administrator), and so on.

In some embodiments, the HW abstraction layer 222 can maintain a logical view of the HW nexthop table 204. In accordance with the present disclosure, updates to the logical view can be reflected in the hardware tables 204, 206 by issuing edit requests (edits) 234 to the HW nexthop table update manager 224. The HW nexthop table update manager, in turn, can issue operations or requests to the hardware tables 204, 206. In accordance with some embodiments, the HW nexthop table update manager 224 can send update requests 244 and deletion requests 246 to the hardware tables 204, 206 immediately without delay. In accordance with the present disclosure, the HW nexthop table update manager may delay sending creation requests 242 to the HW nexthop table. This aspect of the present disclosure is discussed in further detail below.

FIG. 2B represents an embodiment of the forwarding information base that does not use next hop groups. Forwarding information base 200′, in accordance with some embodiments, can comprise hardware tables including IP matching table 252 and a hardware (HW) next hop table 254. The IP matching table comprises entries 252a similar to entries 202a in FIG. 2A. Entries 252a comprise a “nexthop index” data field that points to or otherwise references an entry in the HW nexthop table 254. The HW nexthop table 254 comprises entries 254a that represent a next hop, and can include information that identifies a physical port on the network device that is connected to the next hop device on which an egress packet can be transmitted.

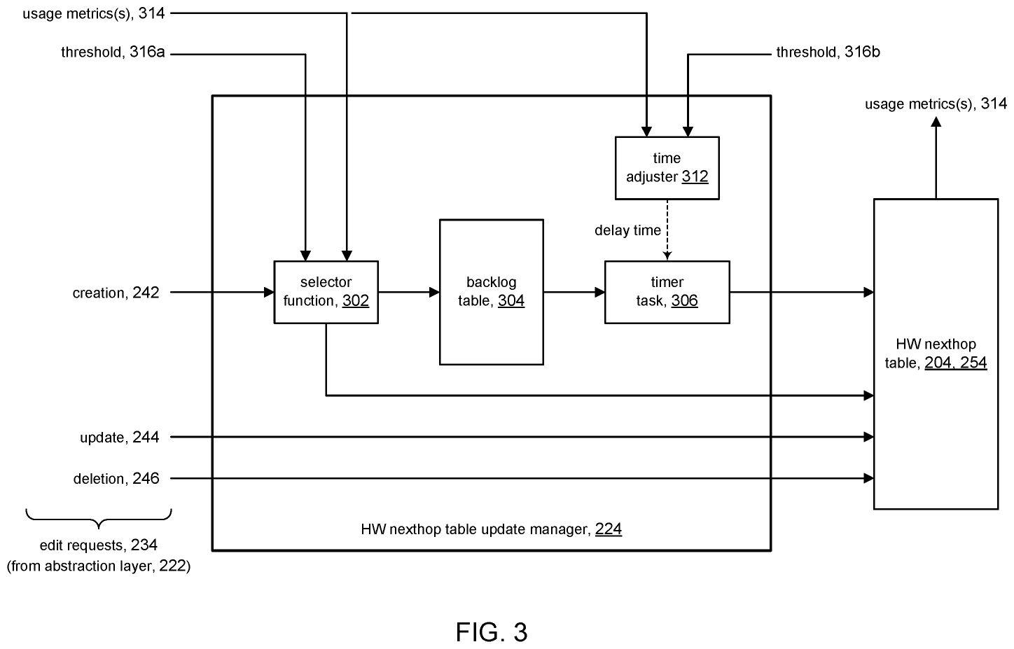

FIG. 3 represents a functional block diagram of the HW nexthop table update manager 224 (update manager) in accordance with the present disclosure. In some embodiments, update manager 224 can include a selector function 302, a backlog table 304, and a timer task 306. The update manager 224 receives edit requests 234 from the HW abstraction layer 222. In some embodiments, the update manager 224 can immediately pass update requests 244 and deletion requests 246 to the HW nexthop table 204 so that the table can make the updates and deletes without delay.

In some embodiments in accordance with the present disclosure, a creation request 242 can be (1) immediately forwarded by selector function 302 to the HW nexthop table 204 where a new entry can be created without delay, or (2) stored by selector 302 to backlog table (or buffer) 304 where the creation of a new entry is delayed. In some embodiments, the selector function 302 can forward or store the creation request based on a comparison between a usage metric 314 and a user-configurable threshold 316a. The usage metric 314 can refer to a level of utilization of the HW nexthop table 204. For example, the usage metric can be the number of used entries in the HW nexthop table expressed as a percentage of the total number of entries in the HW nexthop table. This aspect of the present disclosure is discussed in more detail below.

The timer task 306 can be periodically invoked to forward any creation requests queued up in the backlog table 304 to the HW nexthop table 204 in FIG. 2A or HW nexthop table 254 in FIG. 2A. In some embodiments, for example, the timer task 306 can be a task that delays (sleeps) for a period of time, wakes up to process the backlog table, goes back to sleep and repeats. In some embodiments, a time adjuster 312 can set a delay time value that controls how long the timer task is dormant. The time adjuster 312 can set the delay time to value based on usage metric 314. This aspect of the present disclosure is discussed in more detail below.

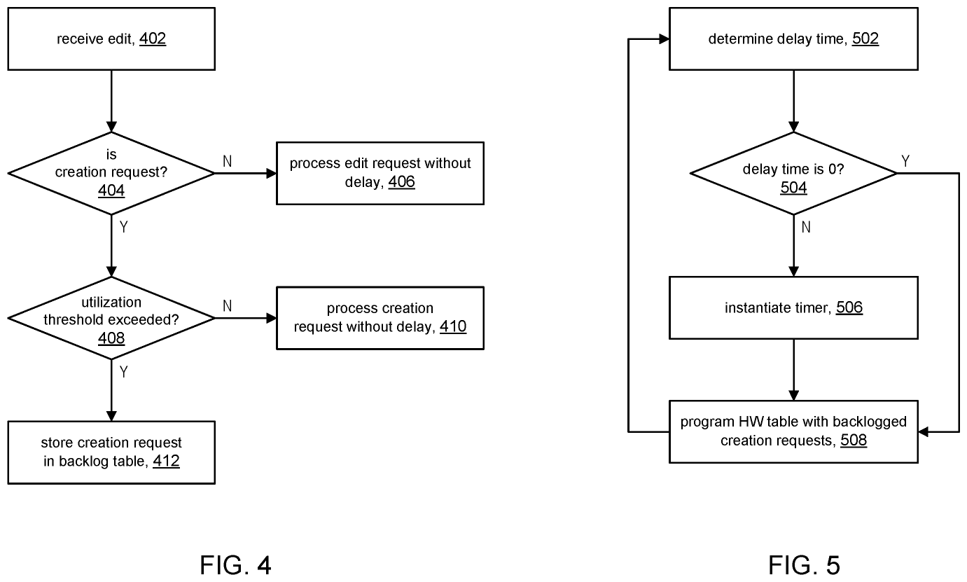

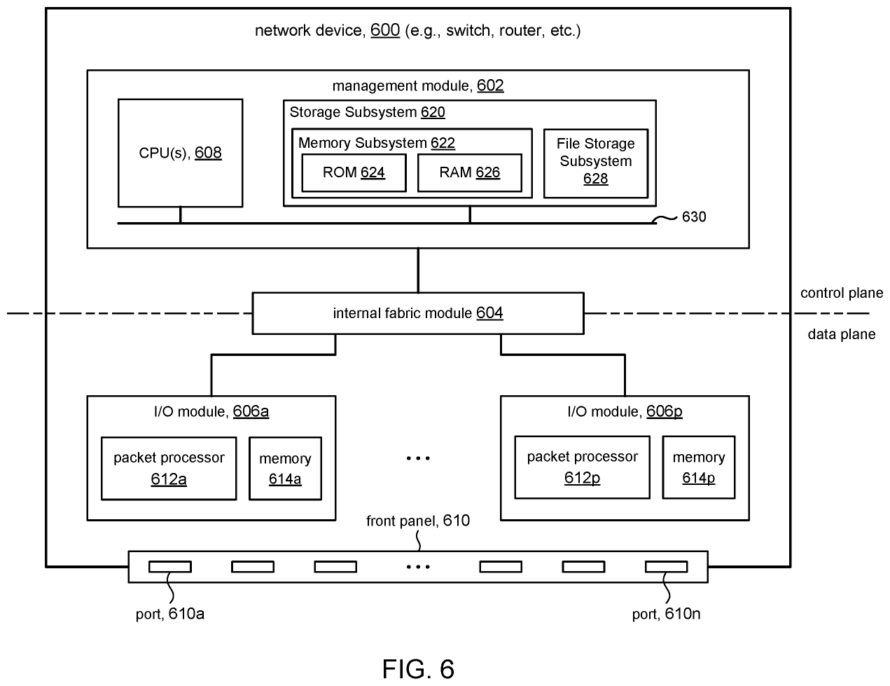

Referring to FIG. 4, the discussion will now turn to a high-level description of processing in a network device (e.g., 104, 106, FIG. 1) to update a HW nexthop table (e.g., 204, 254) in accordance with the present disclosure. In some embodiments, for example, the network device can include one or more digital processing units (circuits), which when operated, can cause the network device to perform processing in accordance with FIG. 4. Depending on a given implementation, the operations may be performed entirely in the control plane, entirely in the data plane, or divided between the control plane and the data plane. Digital processing units (circuits) in the control plane can include general CPUs that operate by way of executing computer program code stored on a non-volatile computer readable storage medium (e.g., read-only memory); for example, CPU 608 in the control plane (FIG. 6) can be a general CPU. Digital processing units (circuits) in the data plane can include specialized processors such as digital signal processors, field programmable gate arrays, application specific integrated circuits, and the like, that operate by way of executing computer program code or by way of logic circuits being configured for specific operations. For example, each of packet processors 612a-612p in the data plane (FIG. 6) can be a specialized processor. The operation and processing blocks described below are not necessarily executed in the order shown. Operations can be combined or broken out into smaller operations in various embodiments. Operations can be allocated for execution among one or more concurrently executing processes and/or threads.

At operation 402, the network device can receive an edit request (e.g., from the HW abstraction layer 222) to edit an entry in the HW nexthop table (e.g., 204, 254). In some embodiments, the edit request can be a request to add (program) a new entry (i.e., a group of next hops) to the HW nexthop table, update an existing entry in the HW nexthop table, or delete an entry in the HW nexthop table. Edit requests may be issued in response to routes being learned, routes being created/changed by a user, and so on.

At decision point 404, if the edit request is not a creation request (e.g., the edit request is either an update request or a delete request), then processing can continue to operation 406. If the edit request is a creation request, then processing can continue to decision point 408.

At operation 406, in response to a determination that the edit request is not a creation request, the network device can process the edit request without delay. It can be appreciated that an update request or a delete request does not consume any entries in the HW nexthop table. An update request operates on an existing entry in the HW nexthop table (e.g., adding or deleting a next hop from the next hop group in the entry) and a delete request deletes an existing entry in the HW nexthop table. Because entries in the HW nexthop table are not consumed, there is no risk in exceeding the capacity of the HW nexthop table, and so the operation can be performed immediately without delay. Processing the received edit request can be deemed complete.

At decision point 408, in response to a determination (at decision point 404) that the edit request is a creation request, the network device can determine whether to forward the creation request to the HW nexthop table or to buffer it. In some embodiments, for example, the network device can compare a usage metric (e.g., 314) that represents a level of utilization of the HW nexthop table against a threshold value. In some embodiments, for example, the threshold value (e.g., 316a) can be the number of used entries expressed as a percentage of the total capacity of the HW nexthop table. For example, a threshold value of 90% can mean that 90% of the entries in the HW nexthop table are used. If the usage metric is less than or equal to the threshold value, then processing can proceed to operation 410. If the usage metric is greater than the threshold value, then processing can proceed to operation 412.

At operation 410, in response to a determination that utilization of the HW nexthop table is less than or equal to the threshold value, the network device can process the creation request without delay to add (program) a new entry to the HW nexthop table with nexthop information contained in the creation request. Processing the received edit request can be deemed complete.

At operation 412, in response to a determination (at decision point 408) that utilization of the HW nexthop table exceeds the threshold value, the network device can store (buffer) the creation request in a backlog table (e.g., 304). Processing the received edit request can be deemed complete.

By buffering creation requests in the backlog table when HW nexthop table utilization is deemed high (e.g., exceeds a threshold value), the network device can slow down or otherwise dampen the creation rate of entries in the HW nexthop table to reduce the risk of overflowing the HW nexthop table in case of transient conditions, where routes are spuriously and frequently created and deleted. Accordingly, at operation 410, when utilization of the HW nexthop table falls below the threshold value, it can be deemed to be safe to program new entries in the HW nexthop table with little risk of overflowing the HW nexthop table even under transient conditions. However, when table utilization exceeds the threshold, the HW nexthop table can be deemed to be at risk of overflow due to transient activity.

Referring to FIG. 5, the discussion will now turn to a high-level description of additional processing in a network device, in accordance with some embodiments, to drain the backlog table to update the HW nexthop table with backlogged creation requests. In some embodiments, for example, the network device can include one or more digital processing units (circuits), which when operated, can cause the network device to perform processing in accordance with FIG. 5. Depending on a given implementation, the operations may be performed entirely in the control plane, entirely in the data plane, or divided between the control plane and the data plane. Digital processing units (circuits) in the control plane can include general CPUs that operate by way of executing computer program code stored on a non-volatile computer readable storage medium (e.g., read-only memory); for example, CPU 608 in the control plane (FIG. 6) can be a general CPU. Digital processing units (circuits) in the data plane can include specialized processors such as digital signal processors, field programmable gate arrays, application specific integrated circuits, and the like, that operate by way of executing computer program code or by way of logic circuits being configured for specific operations. For example, each of packet processors 612a-612p in the data plane (FIG. 6) can be a specialized processor. The operation and processing blocks described below are not necessarily executed in the order shown. Operations can be combined or broken out into smaller operations in various embodiments. Operations can be allocated for execution among one or more concurrently executing processes and/or threads.

At operation 502, the network device can determine a delay time for a timer task. In some embodiments, the delay time can be selected based on how much of the HW nexthop table is utilized. The delay time can be expressed in units of milliseconds. In some embodiments, the delay time can be an integral multiple of a processing time quantum, which refers to a minimum unit of time that a task can run, and is dependent on the operating system of the network device. The delay time can increase as HW nexthop table utilization increases, up to some maximum value. Conversely, the delay time can decrease as HW nexthop table utilization decreases. The delay time can go to zero (0 seconds) when table utilization falls below a threshold value (e.g., 316b). In some embodiments, the delay time can vary exponentially with HW nexthop table utilization.

At decision point 504, if the delay time is zero then processing can proceed directly to operation 508 without delay. If the delay time is not zero then processing can proceed to operation 506.

At operation 506, the network device can instantiate a timer task (e.g., 306) to run for a duration based on the delay time. It will be apparent that the delay time represents a period of time between successive runs to drain the backlog table. Upon expiration of the timer task, the processing can proceed to operation 508.

At operation 508, the network device can program new entries in the HW nexthop table by draining the backlog table. Creation requests stored/buffered in the backlog table (see operation 412) can be processed one request at a time to program new entries in the HW nexthop table. Draining the backlog table can include the following considerations:
In some embodiments, creation requests can be drained from the backlog table in first-in first-out order. In other words, creation requests that are stored/buffered in the backlog table earlier in time will be drained first.
In other embodiments, creation requests can be drained in order of priority. For example, creation requests can be stored in the backlog table in sorted order based on the number of routes that use the entries. Creation requests for entries that are used by the most routes can be drained first (i.e., the nexthops and corresponding routes are programmed), then those entries that are used by the next most number of routes can be drained next, and so on. Prioritizing the creation requests in this way can reduce the likelihood of programming transient entries only to be removed a short time later.
In some embodiments, draining the backlog table can run for a duration based on time; e.g., drain as many backlogged creation requests as possible in some period of time. In some embodiments, the period of time can be based on HW nexthop table utilization. The unit of time can be in milliseconds, units of processing time quanta, and so on.
In other embodiments, draining the backlog table can run for a duration based on draining some number of backlogged creation requests; e.g., drain x number of backlogged creation requests for a given run. The number of backlogged creation requests to drain can vary based on the level of utilization of the HW nexthop table.
   Upon completion of a run of the draining operation, processing can return to operation 502.

The following example illustrates a benefit of the foregoing. When hardware resource usage (e.g., entries in HW nexthop table 204 or HW nexthop table 254) exceeds the limits of the hardware, entries may be deleted in anticipation of accommodating new routes. If the hardware limit is reached due to transient activity causing routes to spuriously and frequently created and deleted, some of the more stable routes may be deleted routes to accommodate transient routes leading to unnecessary traffic drops. Consider the following example:
Suppose, for discussion purposes, the hardware can accommodate a total of three nexthop entries. Consider the following initial configuration at time t0:

R1→N1, R2→N1, R3→N2
where routes R1 and R2 point to (use) nexthop N1 and route R3 points to the nexthop N2. At time t0, therefore, the nexthops N1 and N2 are programmed in the hardware, leaving one more entry in the hardware.
Suppose, at time t1, we want the following steady state configuration to be programmed in the hardware, for example because of some event in the switch:

R1→N3, R2→N3, R3→N4
where routes R1 and R2 should point to a nexthop N3 and route R4 should point to a nexthop N4.
Suppose a transient condition occurs at a time subsequent to t0 and prior to t1 where the following route assignment occurs:

R1→N1, R2→N3, R3→N4
where route R2 uses N3 and route R3 uses N4. This transient occurrence results in N3 being programmed into the hardware; because only N1 and N2 are programmed in the hardware at this time, N3 can be programmed without having to delete N1 or N2. As for programming N4, the operation would fail because all three entries in the hardware are now consumed. In order to program N4, R3 would have to be deleted from the IP matching table 202 or IP matching table 252, so that the use count on N2 goes to zero and the entry in the HW nexthop table that contains N2 can be deleted to make room for N4. After N4 is programmed, R3 can be reprogrammed in the IP matching table to point to N4. The deletion and re-addition of route R3 from the IP matching table can lead to unnecessary traffic loss for packets hitting R3.
However, by dampening or otherwise slowing down the programming of N4 in accordance with the present disclosure, the following transient state can exist:

R1→N3, R2→N3, R3→N2
This would give time for the nexthop NI to be deleted from the hardware because no route is referencing it now. Deleting N1 frees up resources (e.g., an entry) in the hardware to program N4 to be used by route R3. Note that while the programming of N4 is dampened (delayed in the backlog buffer), route R3 will continue to forward traffic on N2.

FIG. 6 is a schematic representation of a network device 600 (e.g., a router, switch, firewall, and the like) that can be adapted in accordance with the present disclosure. In some embodiments, for example, network device 600 can include a management module 602, an internal fabric module 604, one or more I/O modules 606a-606p, and a front panel 610 of I/O ports (physical interfaces) 610a-610n. Management module 602 can constitute the control plane (also referred to as a control layer or simply the CPU) of network device 600 and can include one or more management CPUs 608 for managing and controlling operation of network device 600 in accordance with the present disclosure. Each management CPU 608 can be a general-purpose processor, such as an Intel®/AMD® ×86, ARM® microprocessor and the like, that operates under the control of software stored in a memory device/chips such as ROM (read-only memory) 624 or RAM (random-access memory) 626. The control plane provides services that include traffic management functions such as routing, security, load balancing, analysis, and the like.

The one or more management CPUs 608 can communicate with storage subsystem 620 via bus subsystem 630. Other subsystems, such as a network interface subsystem (not shown in FIG. 6), may be on bus subsystem 630. Storage subsystem 620 can include memory subsystem 622 and file/disk storage subsystem 628. Memory subsystem 622 and file/disk storage subsystem 628 represent examples of non-transitory computer-readable storage devices that can store program code and/or data, which when executed by one or more management CPUs 608, can cause one or more management CPUs 608 to perform operations in accordance with embodiments of the present disclosure.

Memory subsystem 622 can include a number of memories such as main RAM 626 (e.g., static RAM, dynamic RAM, etc.) for storage of instructions and data during program execution, and ROM (read-only memory) 624 on which fixed instructions and data can be stored. File storage subsystem 628 can provide persistent (i.e., non-volatile) storage for program and data files, and can include storage technologies such as solid-state drive and/or other types of storage media known in the art.

Management CPUs 608 can run a network operating system stored in storage subsystem 620. A network operating system is a specialized operating system for network device 600. For example, the network operating system can be the Arista Extensible Operating System (EOS®), which is a fully programmable and highly modular, Linux-based network operating system, developed and sold/licensed by Arista Networks, Inc. of Santa Clara, California. Other network operating systems may be used.

Bus subsystem 630 can provide a mechanism for the various components and subsystems of management module 602 to communicate with each other as intended. Although bus subsystem 630 is shown schematically as a single bus, alternative embodiments of the bus subsystem can utilize multiple busses.

Internal fabric module 604 and the one or more I/O modules 606a-606p can be collectively referred to as the data plane of network device 600 (also referred to as data layer, forwarding plane, etc.). Internal fabric module 604 represents interconnections among the various other modules of network device 600. I/O modules 606a-606p can include respective packet processing hardware circuits comprising packet processors 612a-612p and memory hardware 614a-614p, to provide packet processing and forwarding capability. Each I/O module 606a-606p can be further configured to communicate over one or more ports 610a-610n on the front panel 610 to receive and forward network traffic. Packet processors 612a-612p can comprise hardware (circuitry), including for example, data processing hardware such as an ASIC (application specific integrated circuit), FPGA (field programmable gate array), digital processing unit, and the like. Memory hardware 614a-614p can include lookup hardware, for example, content addressable memory such as TCAMs (ternary CAMs) and auxiliary memory such as SRAMs (static RAMs). The forwarding hardware in conjunction with the lookup hardware can provide wire speed decisions on how to process ingress packets and outgoing packets for egress.

It will be appreciated by persons of ordinary skill in the art that some aspects of the present disclosure may be performed in the control plane while other aspects of the present disclosure may be performed in the data plane. Persons of ordinary skill will understand that in some instances, the present disclosure may be performed wholly within the control plane or wholly within the data plane.

### Further Examples

Features described above as well as those claimed below may be combined in various ways without departing from the scope hereof. The following examples illustrate some possible, non-limiting combinations:
(A1) A method for updating a hardware (HW) nexthop table in a network device, the method comprising: receiving a creation request that specifies a next hop entry to be added to the HW nexthop table, the next hop entry specifying one or more next hops; when a level of utilization of the HW nexthop table is equal to or exceeds a threshold value, adding the creation request to a backlog table; when the level of utilization of the HW nexthop table is less than the threshold value, adding the next hop entry specified in the creation request to the HW nexthop table; and scheduling a task to run periodically, wherein the task drains the backlog table by adding next hop entries specified in one or more creation requests in the backlog table to the HW nexthop table, wherein the task runs for a first period of time, wherein the task delays for a second period of time between runs.
(A2) The method denoted as (A1), further comprising receiving update requests to update next hop entries in the HW nexthop table and deletion requests to delete next hop entries from the HW nexthop table, wherein the update requests and deletion requests are performed without delay.
(A3) For the method denoted as any of (A1) through (A2), the level of utilization of the HW nexthop table is the number of used table entries in the HW nexthop table expressed as a percentage of the total number of table entries in the HW nexthop table.
(A4) For the method denoted as any of (A1) through (A3), the first period of time varies depending on the level of utilization of the HW nexthop table.
(A5) For the method denoted as any of (A1) through (A4), the second period of time varies depending on the level of utilization of the HW nexthop table.
(A6) For the method denoted as any of (A1) through (A5), the first period of time is an integral number of processing time quanta of the network device.
(A7) For the method denoted as any of (A1) through (A6), next hop entries in the backlog table are added to the HW nexthop table in priority order from high priority to low priority, wherein a priority of a next hop is based on how many routes reference that next hop entry.
(A8) The method denoted as any of (A1) through (A7), further comprising reprogramming previously programmed routes that now reference next hop entries that are added to the hardware table, wherein the previously programmed routes are reprogrammed in priority order according to the priorities of the added next hop entries.
(B1) A network device comprising: one or more computer processors; and a computer-readable storage device comprising instructions for controlling the one or more computer processors to: receive a request to create an entry in a HW nexthop table; process the received request by either: storing the received request in a buffer when utilization of the HW nexthop table is equal to or exceeds a threshold value; or creating an entry in the HW nexthop table and storing next hop information in the received request into the created entry when utilization of the HW nexthop table is less than the threshold value; and periodically drain the buffer to create entries in the HW nexthop table in accordance with one or more buffered requests.
(B2) For the network device denoted as (B1), the computer-readable storage device further comprises instructions for controlling the one or more computer processors to receive requests to update next hop entries in the HW nexthop table and requests to delete next hop entries from the HW nexthop table and perform the requests to update and the requests to delete without delay.
(B3) For the network device denoted as any of (B1) through (B2), utilization of the HW nexthop table refers to the number of used table entries in the HW nexthop table expressed as a percentage of the total number of table entries in the HW nexthop table.
(B4) For the network device denoted as any of (B1) through (B3), a period of time between successive runs of draining the buffer to create entries in the HW nexthop table varies depending on the level of utilization of the HW nexthop table.
(B5) For the network device denoted as any of (B1) through (B4), draining the buffer to create entries in the HW nexthop table runs for a duration that varies depending on the level of utilization of the HW nexthop table.
(B6) For the network device denoted as any of (B1) through (B5), the duration is based on (1) time or (2) a number of buffered requests.
(B7) For the network device denoted as any of (B1) through (B6), buffered requests are drained from the buffer in priority order from high priority to low priority, wherein a priority of a request is based on how many routes reference the next hop information in the request.
(C1) A method in a network device comprising: receiving a request to create an entry in a HW nexthop table; processing the received request by either: storing the received request in a buffer when utilization of the HW nexthop table is equal to or exceeds a threshold value; or creating an entry in the HW nexthop table and storing next hop information in the received request into the created entry when utilization of the HW nexthop table is less than the threshold value; and periodically draining the buffer to create entries in the HW nexthop table in accordance with one or more buffered requests.
(C2) For the method denoted as (C1), utilization of the HW nexthop table refers to the number of used table entries in the HW nexthop table expressed as a percentage of the total number of table entries in the HW nexthop table.
(C3) For the method denoted as any of (C1) through (C2), a period of time between successive runs of draining the buffer varies depending on the level of utilization of the HW nexthop table.
(C4) For the method denoted as any of (C1) through (C3), draining the buffer to create entries in the HW nexthop table runs for a duration that varies depending on the level of utilization of the HW nexthop table.
(C5) For the method denoted as any of (C1) through (C4), buffered requests are drained from the buffer in priority order from high priority to low priority, wherein a priority of a request is based on how many routes reference the next hop information in the request.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method for updating a hardware (HW) nexthop table in a network device, the method comprising:
receiving a creation request that specifies a next hop entry to be added to the HW nexthop table, the next hop entry specifying one or more next hops;
when a level of utilization of the HW nexthop table is equal to or exceeds a threshold value, adding the creation request to a backlog table;
when the level of utilization of the HW nexthop table is less than the threshold value, adding the next hop entry specified in the creation request to the HW nexthop table; and
scheduling a task to run periodically, wherein the task drains the backlog table by adding next hop entries specified in one or more creation requests in the backlog table to the HW nexthop table, wherein the task runs for a first period of time, wherein the task delays for a second period of time between runs.

2. The method of claim 1, further comprising receiving update requests to update next hop entries in the HW nexthop table and deletion requests to delete next hop entries from the HW nexthop table, wherein the update requests and deletion requests are performed without delay.

3. The method of claim 1, wherein the level of utilization of the HW nexthop table is the number of used table entries in the HW nexthop table expressed as a percentage of the total number of table entries in the HW nexthop table.

4. The method of claim 1, wherein the first period of time varies depending on the level of utilization of the HW nexthop table.

5. The method of claim 1, wherein the second period of time varies depending on the level of utilization of the HW nexthop table.

6. The method of claim 1, wherein the first period of time is an integral number of processing time quanta of the network device.

7. The method of claim 1, wherein next hop entries in the backlog table are added to the HW nexthop table in priority order from high priority to low priority, wherein a priority of a next hop is based on how many routes reference that next hop entry.

8. The method of claim 7, further comprising reprogramming previously programmed routes that now reference next hop entries that are added to the hardware table, wherein the previously programmed routes are reprogrammed in priority order according to the priorities of the added next hop entries.

9. A network device comprising:
one or more computer processors; and
a computer-readable storage device comprising instructions for controlling the one or more computer processors to:
receive a request to create an entry in a HW nexthop table;
process the received request by either:
storing the received request in a buffer when utilization of the HW nexthop table is equal to or exceeds a threshold value; or
creating an entry in the HW nexthop table and storing next hop information in the received request into the created entry when utilization of the HW nexthop table is less than the threshold value; and
periodically drain the buffer to create entries in the HW nexthop table in accordance with one or more buffered requests.

10. The network device of claim 9, wherein the computer-readable storage device further comprises instructions for controlling the one or more computer processors to receive requests to update next hop entries in the HW nexthop table and requests to delete next hop entries from the HW nexthop table and perform the requests to update and the requests to delete without delay.

11. The network device of claim 9, wherein utilization of the HW nexthop table refers to the number of used table entries in the HW nexthop table expressed as a percentage of the total number of table entries in the HW nexthop table.

12. The network device of claim 9, wherein a period of time between successive runs of draining the buffer to create entries in the HW nexthop table varies depending on the level of utilization of the HW nexthop table.

13. The network device of claim 9, wherein draining the buffer to create entries in the HW nexthop table runs for a duration that varies depending on the level of utilization of the HW nexthop table.

14. The network device of claim 13, wherein the duration is based on (1) time or (2) a number of buffered requests.

15. The network device of claim 9, wherein buffered requests are drained from the buffer in priority order from high priority to low priority, wherein a priority of a request is based on how many routes reference the next hop information in the request.

16. A method in a network device comprising:
receiving a request to create an entry in a HW nexthop table;
processing the received request by either:
storing the received request in a buffer when utilization of the HW nexthop table is equal to or exceeds a threshold value; or
creating an entry in the HW nexthop table and storing next hop information in the received request into the created entry when utilization of the HW nexthop table is less than the threshold value; and
periodically draining the buffer to create entries in the HW nexthop table in accordance with one or more buffered requests.

17. The method of claim 16, wherein utilization of the HW nexthop table refers to the number of used table entries in the HW nexthop table expressed as a percentage of the total number of table entries in the HW nexthop table.

18. The method of claim 16, wherein a period of time between successive runs of draining the buffer varies depending on the level of utilization of the HW nexthop table.

19. The method of claim 16, wherein draining the buffer to create entries in the HW nexthop table runs for a duration that varies depending on the level of utilization of the HW nexthop table.

20. The method of claim 16, wherein buffered requests are drained from the buffer in priority order from high priority to low priority, wherein a priority of a request is based on how many routes reference the next hop information in the request.
